(19) United States
(12) Patent Application Publication
(10) Pub. No.: US 2005/0190441 A1
(43) Pub. Date: Sep. 1, 2005

(54) Binoculars

(75) Inventors: Satoru Nemoto, Saitama-ken (JP); Ken Hirunuma, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/052,042

(22) Filed: Feb. 8, 2005

(30) Foreign Application Priority Data
Feb. 9, 2004 (JP) 2004-032561

(51) Int. Cl. G02B 23/00; G02B 27/64

(52) U.S. Cl. 359/410; 359/407

(57) ABSTRACT

The binoculars include a focusing mechanism and a convergence value compensating mechanism. A convergence value is compensated by turning displaceable elements which are at least parts of the objective optical systems, respectively, centering around straight lines parallel to the optical axes thereof in association with actuation of the focusing mechanism to vary a distance between the optical axes of the displaceable elements. When viewed along the optical axis direction of the objective optical systems, a condition α<β is satisfied, where, α represents an inclination angle of a line segment connecting the centers of the displaceable elements with the turning centers thereof, respectively, with respect to the vertical direction of the binoculars in a state where an object at infinity is focused, and β represents an inclination angle in a state where an observation object at the shortest distance is focused.

### BACKGROUND OF THE INVENTION

The present invention relates to binoculars.

When an object at infinity is observed by a pair of binoculars, a field of view observed by a left eye of an observer and a field of view observed by the right eye substantially overlap each other, and a single field of view is observed when the observer observes the binoculars with both eyes. When an object at a relatively short distance of several meters or less is observed with the binoculars, only a part of the field of view for each of the right eye and left eye overlaps each other, and the observer feels difficulty in observing such an object. This is because, in binoculars, the optical axes of left and right objective lenses are generally fixed to be parallel to each other since the binoculars are generally designed to observe an object located within a range from several tens of meters to infinity. If an object at a short distance is observed with such binoculars, a remarkable discrepancy arises between a focusing condition corresponding to the object (which will be referred to as an adjustment value, i.e., a distance to an object to be focused, for example, represented by a unit of diopter [dptr]=[1/meter]) and convergence value (which is a distance at which a right sight line and a left sight line cross, for example, represented by metric angle [MW]=[1/meter]). When an object is observed at high magnifying power, an influence due to such discrepancy is remarkable. For example, with ten-power binoculars, the degree of discrepancy is ten times in comparison with the degree of discrepancy of naked eyes. The remarkable discrepancy between the adjustment value and convergence value is a burden to the eyes of the observer and causes the eyes to be fatigued. (It should be noted that the term “convergence” means the visual axes of both eyes which are concentrated when observing an object at a short distance, and the angle formed between both axes is referred to as a “convergence angle”).

In view of the above-described problem, in order to reduce the burden to the eyes when observing an object at a short distance, binoculars provided with a convergence value (convergence angle) compensating mechanism have been developed. In such binoculars, in accordance with the adjustment value, the convergence value (or convergence angle) is adjusted by moving both objective lenses in the direction orthogonal to the optical axes thereof to make the objective lenses located close to each other when observing an object at a short distance. Examples of such binoculars are disclosed in Japanese Patent Publications No. 3090007, No. 3196613 and No. 3189328. However, the structure of a convergence value compensating mechanism of the binoculars described in each of the patent publications is relatively complicated.

For example, the mechanism shown in FIG. 8 of publication No. 3196613 is configured such that the objective lens is moved along two upper and lower guide rods and an auxiliary rod. In this mechanism, the guide rods and auxiliary rod should be prepared separately from a lens frame of each objective lens and implemented in the lens frame. In such a configuration, the number of components is increased, manufacturing and assembling thereof are relatively difficult, and thus the manufacturing costs increases. In addition, since each of the guide rods and auxiliary rod is straight, the inclination angle should be made constant. Therefore, it is difficult to optimally compensate for the convergence value in accordance with a focusing operation.

In the mechanism shown in FIG. 4 of publication No. 3196613, the objective lens is supported in the objective lens frame so as to be movable in a direction perpendicular to the optical axis direction, and the objective lens frame is movably supported in the lens barrel. In the mechanism, it is necessary to provide at least a triple structure in which the lens frames, objective lens frame and lens barrel are employed, thereby resulting in complication and upsizing.

The mechanism shown in FIG. 8 of publication No. 3090007 compensates for the convergence value by moving a prism using a cam. The structure requires, however, two separate actuation mechanisms, including an actuation mechanism for focusing. Therefore, the structure is complicated.

### SUMMARY OF THE INVENTION

The present invention is advantageous in that binoculars capable of compensating for the convergence value with a relatively simple structure but at a high accuracy in accordance with an adjustment value when observing an object at a short distance are provided. Generally, the binoculars are used most frequently to observe objects at or in the vicinity of the infinity. According to the binoculars embodying the invention, a relatively high optical performance can be expected when an object is located at or in the vicinity of the infinity.

According to an aspect of the invention, there is provided binoculars which include a pair of observation optical systems each having an objective optical system, an erecting optical system and an eyepiece optical system. The binoculars include a focusing mechanism that is used to move a part of the observation optical system for focusing, a convergence value compensating mechanism that compensates for a convergence value by turning displaceable elements which are at least parts of the objective optical systems, respectively, centering around straight lines parallel to the optical axes of the displaceable elements in association with actuation of the focusing mechanism to vary a distance between the optical axes of the displaceable elements. When viewed along the optical axis direction of the objective optical systems, the centers of the displaceable elements are located on outer sides of lines respectively passing the turning centers of the displaceable elements and parallel to the vertical direction of the binoculars in a state where an observation object at infinity is focused. Further, when viewed along the optical axis direction of the objective optical systems, the centers of the displaceable elements are located on inner sides of lines respectively passing the turning centers of the displaceable elements and parallel to the vertical direction of the binoculars in a state where an observation object at a closest focusable distance is focused. Furthermore, a condition:
α<β
is satisfied,
where, α represents an inclination angle of a line segment connecting the centers of the displaceable elements with the turning centers thereof, respectively, with respect to the vertical direction of the binoculars in a state where an object at infinity is focused, and β represents an inclination angle of a line segment connecting the centers of the respective object displacement elements to the turning centers thereof, respectively, with respect to the vertical direction in a state where an observation object at the closest focusable distance is focused.

According to another aspect of the invention, there is provided binoculars which include a pair of observation optical systems each having an objective optical system, an erecting optical system and an eyepiece optical system. The binoculars include a focusing mechanism that is used to move a part of the observation optical system for focusing, a convergence value compensating mechanism that compensates for a convergence value by turning displaceable elements which are at least parts of the objective optical systems, respectively, centering around straight lines parallel to the optical axes of the displaceable elements in association with actuation of the focusing mechanism to vary a distance between the optical axes of the displaceable elements. Further, when viewed in the optical axis direction of the objective optical-systems, a line segment connecting each of the centers of the displaceable elements with corresponding one of the turning centers of the displaceable elements is substantially parallel to the vertical direction of the binoculars in a state where an observation object at infinity is focused. Furthermore, when viewed in the optical axis direction of the objective optical systems, a line segment connecting each of the centers of the displaceable elements with corresponding one of the turning centers of the displaceable elements is on an inner side of a line passing the turning center of the corresponding one of the displaceable elements and in parallel with the vertical direction of the binoculars in a state where an observation object at minimum focusable distance is focused.

Optionally, each of the pair of observation optical systems is configured such that an incidence side optical axis and an emission side optical axis with respect to the erecting optical system are shifted from each other by a predetermined distance. Further, the binoculars may include a main body that accommodates the pair of displaceable elements, a left barrel containing the left eyepiece optical system and the left erecting optical system, the left barrel being turnable, with respect to the main body, about the left incidence side optical axis of the eyepiece optical system, and a right barrel containing the right eyepiece optical system and the right erecting optical system, the right barrel being turnable, with respect to the main body, about the right incidence side optical axis of the eyepiece optical system. The distance between the emission side optical axes of the pair of eyepiece optical systems may be made adjustable by turning the left barrel and right barrel with respect to the main body.

Further optionally, a focusing mechanism is configured to carry out focusing by moving the pair of displaceable optical elements, and the binoculars may further includes a pair of guide shafts corresponding to the pair of displaceable optical elements, the pair of guide shafts being arranged in parallel with the optical axes of the corresponding displaceable optical elements, the pair of guide shafts guiding the corresponding object displacement elements when moved by actuation of the focusing mechanism, the pair of guide shafts serving as turning centers of the corresponding object displacement elements, respectively, a pair of engaging portions formed on a pair of frames that hold the pair of displaceable optical elements, respectively, and a pair of guide rails provided with respect to the pair of displaceable optical elements, respectively, the pair of engaging portions being slidably engaged with the pair of guide rails, respectively, the pair of guide rails having inclined portions that incline with respect to the optical axes of the pair of displaceable optical elements at at least parts thereof, respectively. With this configuration, when the pair of displaceable optical elements are moved for focusing with the pair of engaging portions being engaged with the inclined portions of the pair of guide rails, respectively, the pair of displaceable optical elements turn about the pair of guide shafts, respectively, a distance between the optical axes of the pair of displaceable optical elements changing as the pair of displaceable optical elements turn, whereby a convergence value is compensated.

Still optionally, when viewed in the optical axes direction of the objective optical systems, a distance from the center of each of the pair of displaceable optical elements to the center of the corresponding one of the pair of guide shafts may be longer than the distance from the center of the displaceable optical element to the engagement portion.

Further, the focusing mechanism may include a focusing ring which is manually operable, and when viewed in the optical axis direction of each of the objective optical systems, the distance from the center of the focusing ring to the center of corresponding one of the pair of guide shafts may be shorter than the distance from the center of the focusing ring to the engagement portion.

Furthermore, the focusing mechanism may include a focusing ring which is manually operable, and when viewed in the optical axis direction of the pair of objective optical systems, the pair guide shafts may be arranged at substantially the same height as that of the focusing ring with respect to the vertical direction of the binoculars.

### BRIEF DESCRIPTION OF THE ACCOMPANYING DRAWINGS

FIG. 1 is a sectional plan view of binoculars according to a first embodiment of the invention in an infinity-focused state;

FIG. 2 is a sectional side view of the binoculars according to the first embodiment of the invention in an infinity-focused state;

FIG. 3 is a sectional front view of the binoculars according to the first embodiment of the invention in an infinity-focused state;

FIG. 4 is a sectional plan view of the binoculars according to the first embodiment of the invention in a shortest distance focused state;

FIG. 5 is a sectional side view of the binoculars according to the first embodiment of the invention in a shortest distance focused state;

FIG. 6 is a sectional front view of the binoculars according to the first embodiment of the invention in a shortest distance focused state;

FIG. 7 is an exemplary view showing displacement amounts of the objective optical systems, which are necessary for convergence value compensation;

FIG. 8 is a sectional front view of the binoculars according to a second embodiment of the invention in an infinity-focused state; and

FIG. 9 is a sectional front view of the binoculars according to the second embodiment of the invention in a shortest distance focused state.

### DETAILED DESCRIPTION OF THE EMBODIMENTS

Hereinafter, binoculars according to embodiments of the present invention will be described in detail with reference to the accompanying drawings.

### First Embodiment

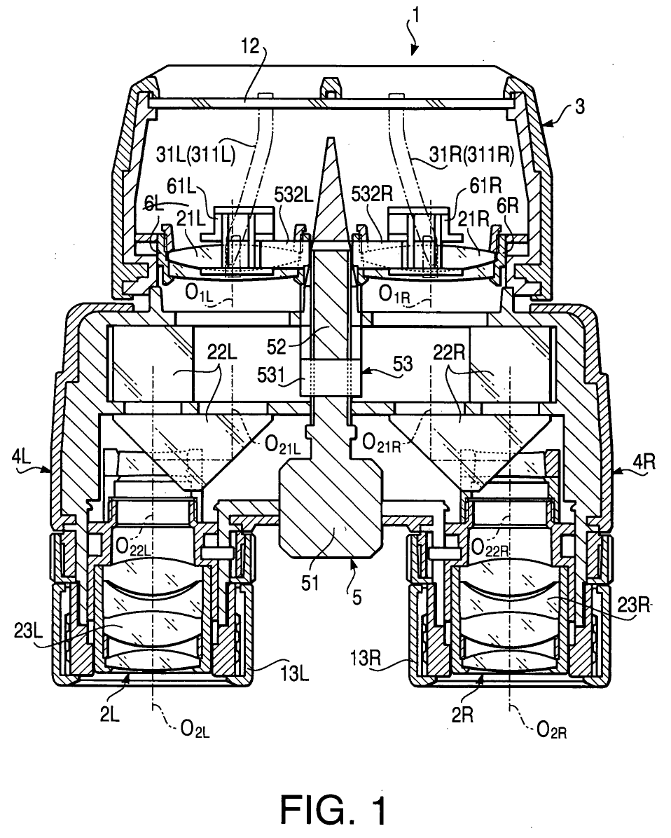

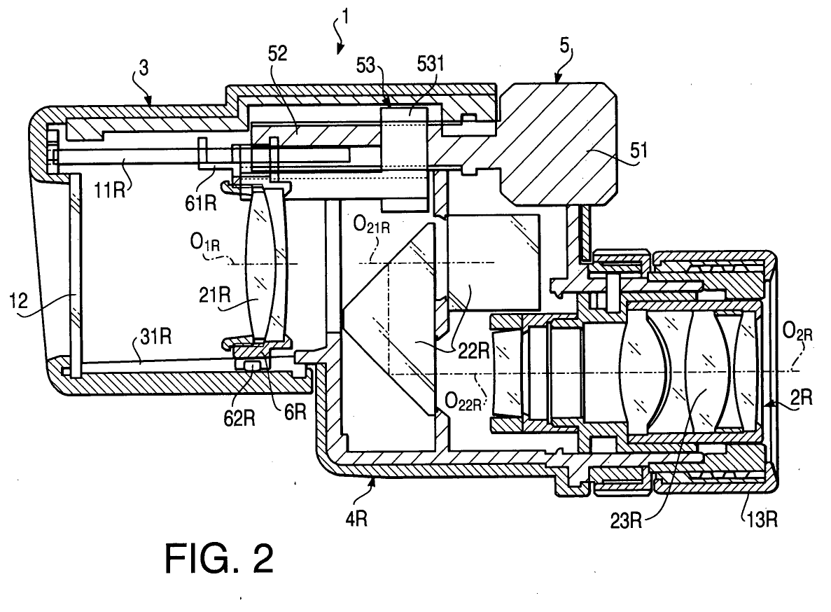

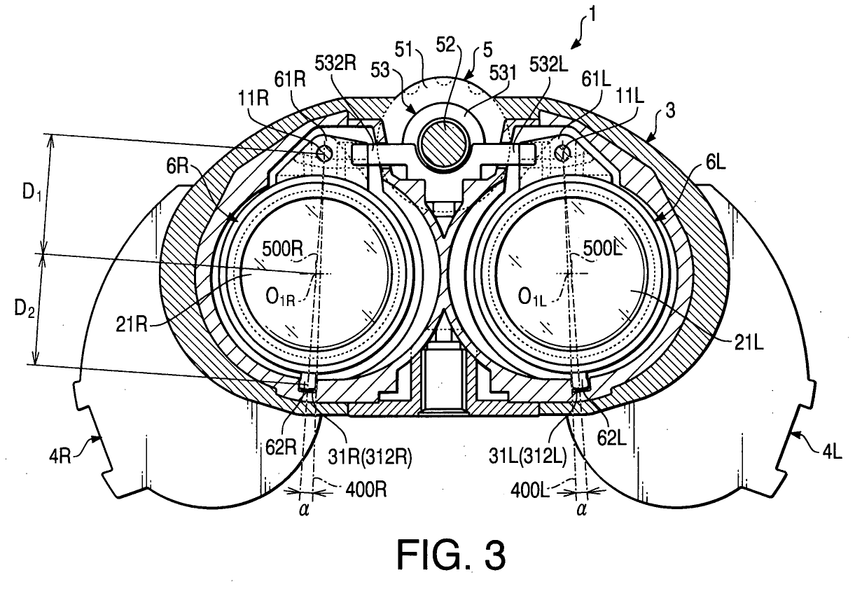

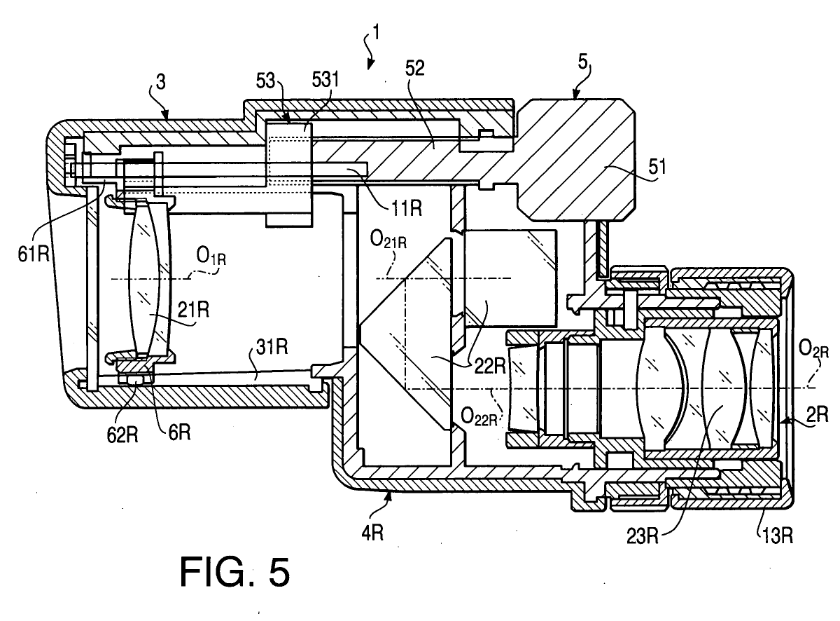

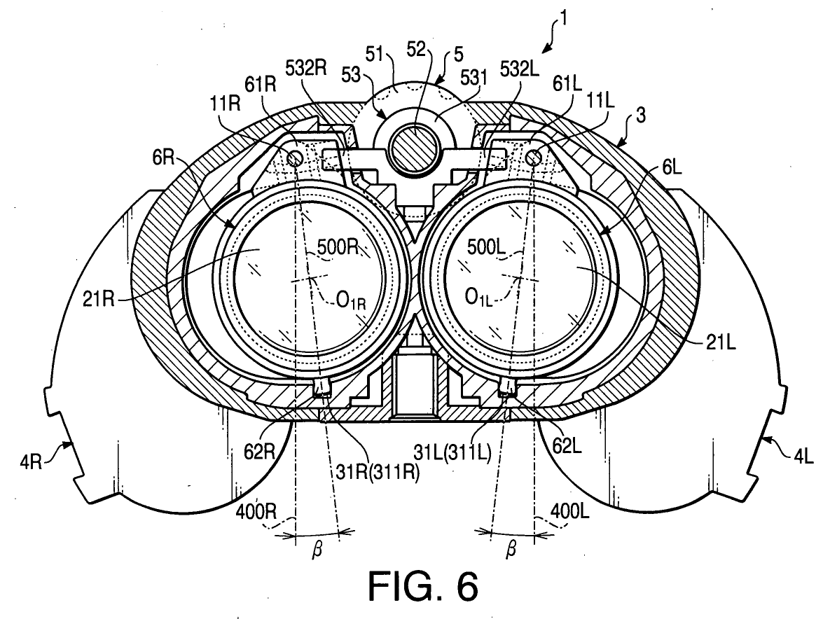

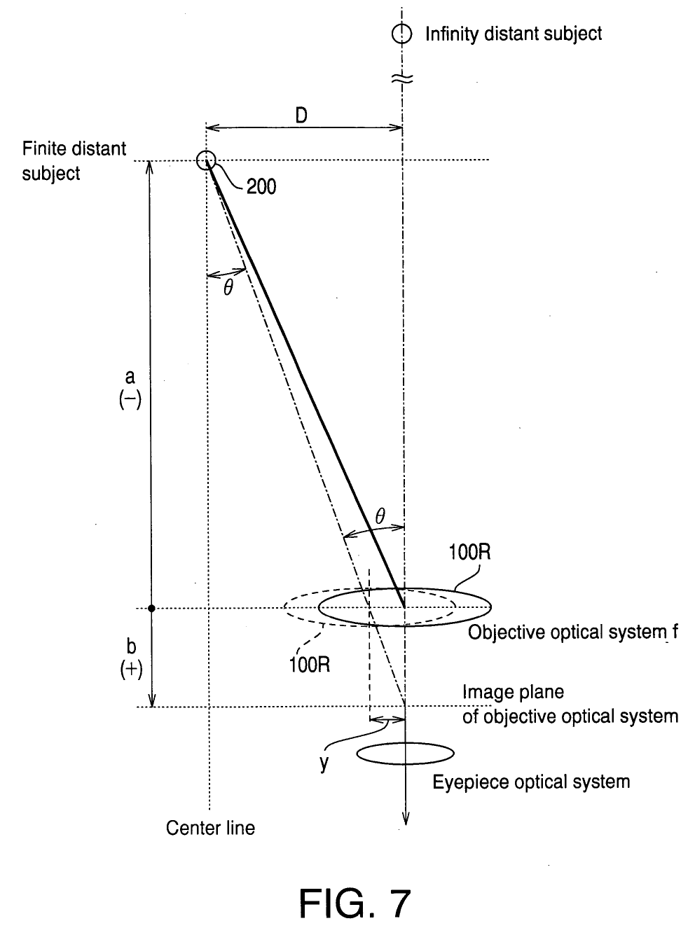

FIG. 1, FIG. 2 and FIG. 3 are cross-sectional plan view, cross-sectional side view and cross-sectional front view of binoculars according to a first embodiment of the invention when the binoculars are focused on an object at infinity (hereinafter, the state will be referred to as the “infinity focused state”). FIG. 5 and FIG. 6 are sectional side view and a sectional front view when the binoculars according to the first embodiment of the invention are focused to an object at its shortest distance (hereinafter, the state will be referred to as the “shortest distance focused state”). FIG. 7 is an exemplary view showing displacement amounts of objective optical systems necessary to compensate for a convergence value.

It should be noted that, in this specification, the upper side in FIG. 1 and the left-hand side in FIG. 2 are referred to as a “front” side of the binoculars, the lower side in FIG. 1 and the right-hand side in FIG. 2 are referred to as a “rear” side of the binoculars 1, the upper side in FIG. 2 and FIG. 3 is referred to as the “up or upside” and the lower side therein is referred to as the “down or downside” of the binoculars 1.

As shown in FIG. 1, the binoculars 1 include an observation optical system 2 L for the left eye, an observation optical system 2R for the right eye, a main body 3 which is a casing for accommodating the above-described observation optical systems 2L, a left barrel 4L and a right barrel 4R, and a focusing mechanism 5 used for focusing in accordance with an object distance.

The observation optical systems 2L and 2R have objective optical systems 21L and 21R, erecting optical systems 22L and 22R and eyepiece optical systems 23L and 23R, respectively. The erecting optical systems 22L and 22R in the observation optical systems 2L and 2R include Porro prisms, respectively. A predetermined gap (spacing) is formed between the incidence side optical axes O_{21L} and O_{21R} of the eyepiece optical systems 23L and 23R with respect to the erecting optical systems 22L and 22R and the emission side optical axes O_{22L} and O_{22R} thereof. In the infinity focused state, the optical axes O_{1L} and O_{1R} of the objective optical systems 21L and 21R coincide with the incidence side optical axes O_{21L} and O_{21R}, respectively.

Both the objective optical systems 21L and 21R are integrally installed in the main body 3. The left side eyepiece optical system 23L and erecting optical system 22L, and the right side eyepiece optical system 23R and erecting optical system 22R are installed in the left barrel 4L and right barrel 4R which are separated from each other. The main body 3, left barrel 4L and right barrel 4R may include a single part or may include a plurality of combined parts.

The left barrel 4L and right barrel 4R are coupled to the main body 3 so as to turn within a predetermined angular range about the incidence side optical axes O₂₁L and O₂₁R, respectively. Further, the barrels 4L and 4R can be held at any positions within the predetermined angular range by friction.

By turning the left barrel 4L and right barrel 4R in opposite directions, the distance between the optical axes O_{2L} and O_{2R} (distance between the emission side optical axes O_{22L} and O_{22R}) of both the eyepiece optical systems 23L and 23R can be adjusted to meet the width between the eyes of the observer. It is preferable that the binoculars 1 are provided with an interlock mechanism (not illustrated) by which the left barrel 4L and right barrel 4R turn in opposite directions simultaneously with each other.

In the composition as illustrated, a cover glass 12 is provided in the window part opening forward of the main body 3. With this configuration, foreign substances or dusty substances are prevented from entering the main body 3. The cover glass 12 may be omitted.

At the rear end portions of the barrels 4L and 4R, eyepiece members 13L and 13R are secured concentrically with the eyepiece optical systems 23L and 23R, respectively. The eyepiece members 13L and 13R are displaceable in the directions of the optical axes O_{2L} and O_{2R}, that is, movable from the accommodated state shown in FIG. 1 to a state (not illustrated) where the eyepiece members 13L and 13R are drawn rearward. The user adjusts the positions of the eyepiece members 13L and 13R depending on the presence/absence of glasses or facial features, and then looks into the eyepiece optical systems 23L and 23R circumocularly or with his/her glasses abutted against the rearward end surface of the eyepiece members 13L and 13R. With this configuration, the user can place his/her eyes at appropriate eye points (the positions where all the fields of view can be seen without being shielded) in a stable state.

The objective optical systems 21L and 21R are made movable with respect to the main body 3, and are moved by actuation of the focusing mechanism 5. As shown in FIG. 2 and FIG. 3, the main body 3 is provided with a pair of guide shafts 11L and 11R and guide grooves (guide rails) 31L and 31R for guiding movement of the objective optical systems 21L and 21R, respectively.

Each of the guide shafts 11L and 11R includes a straight rod. The guide shafts 11L and 11R are arranged on the upper side of the objective optical systems 21L and 21R, extending in parallel with the optical axes O_{1L} and O_{1R}. As shown in FIG. 3, protruded portions 61L and 61R formed on the upside portions of the lens frames 6L and 6R for retaining the objective optical systems 21L and 21R have holes, through which the guide shafts 11L and 11R are inserted. With this configuration, the objective optical systems 21L and 21R are movable along the guide shafts 11L and 11R, and are turnable about the guide shafts 11L and 11R, respectively.

The guide rails 31L and 31R include grooves formed on the inner wall on the lower side of the main body 3. Projections (engagement portions) 62L and 62R, which are inserted into the guide grooves 31L and 31R, are formed downward portions of the lens frames 6L and 6R. As the objective optical systems 21L and 21R are moved along the guide shafts 11L and 11R, the projections 62L and 62R are moved along the guide grooves 31L and 31R, respectively.

As shown in FIG. 1, the focusing mechanism 5 includes a turning ring (focusing ring) 51 which serves as an operable member, a focusing ring shaft 52 which turns along with the focusing ring 51 and a vane 53. Both the focusing ring 51 and focusing ring shaft 52 are located between the observation optical systems 2L and 2R in the plan view and are rotatably supported on the main body 3. The vane 53 is provided with a base portion 531 having a female thread which is engaged with a male thread formed on the outer circumferential surface of the focusing ring-shaft 52. The vane 53 is further provided with arms 532L and 532R protruding leftward and rightward from the proximal portion 531, respectively. The tip end portions of the arms 532L and 532R are inserted into grooves formed in the protruded portions 61L and 61R of the lens frames 6L and 6R.

If the focusing ring 51 is rotated in a predetermined direction, the proximal portion 531 advances along the direction where the focusing ring shaft 52 extends. Then, the force is transmitted to the lens frames 6L and 6R via the arms 532L and 532R to cause the objective optical systems 21L and 21R to protrude forward. If the focusing ring 51 is turned in the direction opposite to the predetermined direction, the objective optical systems 21L and 21R are caused to be retracted rearward. With such actuation of the focusing mechanism 5, focusing can be carried out.

In the infinity focused state shown in FIG. 1 and FIG. 3, the objective optical systems 21L and 21R are in a rearward retracted state (i.e., fully retracted rearward).

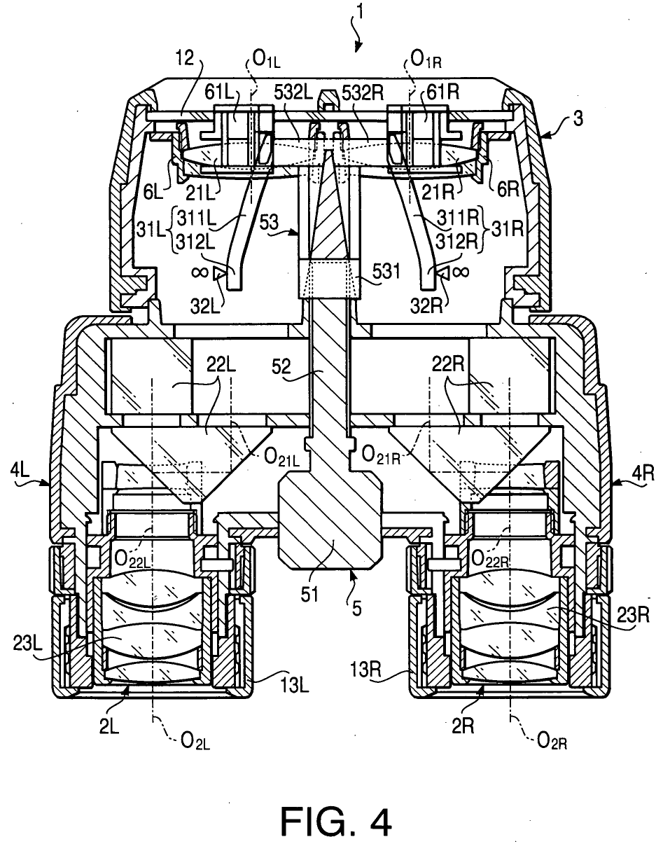

To the contrary, in the shortest distance focused state shown in FIG. 4 through FIG. 6, the objective optical systems 21L and 21R are fully protruded forward. The shortest focusing distance of the binoculars 1 can be obtained in this state. The shortest focusing distance is not limited to a specific value. However, as described below, since the binoculars 1 according to the invention are provided with a convergence value compensation mechanism and are suitable for short distance observation, it is preferable that the shortest focusing distance is relatively short in comparison with conventional binoculars, which distance is, for example, 0.3 m through 1 m in range.

The binoculars 1 are provided with a convergence value compensation mechanism for compensating for the convergence value by varying the distance between the optical axes O_{1L} and O_{1R} of the objective optical systems 21L and 21R in association with the operation of the focusing mechanism 5. In the first embodiment, the convergence value compensation mechanism includes the guide shafts 11L and 11R, guide rails (grooves) 31L and 31R and projections 62L and 62R as described above. Hereinafter, a description is given of compensation for the convergence value in the binoculars 1 according to the first embodiment.

As shown in FIG. 4, the guide rails (grooves) 31L and 32R are provided with inclined portions 311L and 311R extending along a direction inclined with respect to the optical axes O_{1L} and O_{1R} of the objective optical systems 21L and 21R, and parallel portions 312L and 312R continuously formed rearward of the inclined portions 311L and 311R and extending in parallel to the optical axes O_{1L} and O_{1R}, respectively. The inclined portions 311L and 311R are inclined such that the inclined portions 311L and 311R become closer to each other toward the forward direction. Markers 32L and 32R indicating the positions of the objective optical systems 21L and 21R in the infinity focused state are provided sideward at a predetermined position along the parallel portions 312L and 312R.

When the projections 62L and 62R are located at the parallel portions 312L and 312R, even if the focusing mechanism 5 is operated and the objective optical systems 21L and 21R are moved, the distance between the optical axes O_{1L} and O_{1R} does not change. That is, no convergence value compensation is effected in the vicinity of the infinity focused state. It is because, when observing an object at a relatively far distance, the convergence value correction is unnecessary.

When the projections 62L and 62R are located at the inclined portions 311L and 311R, as the focusing mechanism 5 is operated and objective optical systems 21L and 21R is advanced, the projections 62L and 62R approach the center along the inclined portions 311L and 311R, respectively. Thus, the objective optical systems 21L and 21R are rotated about the guide shafts 11L and 11R, respectively, and the distance between the optical axes O_{1L} and O_{1R} is gradually reduced, thereby the convergence value being compensated for (see FIG. 3 and FIG. 6).

Since the convergence value is compensated as described above, a difference between an image observed by the left eye and an image observed by the right eye when observing a short distance object can be prevented, and the observation becomes easy and comfortable.

As described above, in the binoculars 1 according to the first embodiment, an objective optical system turning method is employed, in which the distance between the optical axes O_{1L} and O_{1R} is varied by turning the objective optical systems 21L and 21R centering around the guide axes 11L and 11R when compensating for the convergence value. It should be noted that the objective optical systems 21L and 21R are not translated (i.e., moved in parallel) in the right and left directions. Therefore, the structure can be simplified, which contributes to a decrease in the number of components and facilitation of assembling process, thereby the manufacturing costs thereof being reduced.

In such binoculars 1, as shown in FIG. 3, when viewed along the directions of optical axes O_{1L} and O_{1R}, the centers (optical axes O_{1L} and O_{1R}) of the object optical systems 21L and 21R are located outside straight lines 400L and 400R, which are imaginary lines respectively passing the centers of the guide shafts 11L and 11R, in the infinity focused state. The centers of the guide shafts 11L and 11R are the turning centers of the objective optical systems 21L and 21R and are parallel to the vertical direction of the binoculars 1. To the contrary, as shown in FIG. 6, when viewed in the directions of optical axes O_{1L} and O_{1R}, the centers (optical axes O_{1L} and O_{1R}) of the objective optical systems 21L and 21R are located inside the straight lines 400L and 400R in the shortest distance focused state. That is, line segments 500L and 500R connecting the centers (optical axes O_{1L} and O_{1R}) of the objective optical systems 21L and 21R to the turning centers (centers of the guide shafts 11L and 11R) are inclined in opposite directions, with respect to the vertical direction, in the infinity focused state and in the shortest distance focused state. Further, when inclination angles of the segments 500L and 500R with respect to the vertical direction in the infinity focused state shown in FIG. 3 are represented by α, and the inclination angles of the segments 500L and 500R with respect to the shortest distance focused state shown in FIG. 6 are represented by β, the angle α is smaller than the angle β (i.e., α<β). The above configuration provides the following advantages.

When the objective optical systems 21L and 21R turn about the guide shafts 11L and 11R for convergence value correction, the optical axes O_{1L} and O_{1R} are slightly displaced in the vertical direction. If the displacement amounts of the optical axes O_{1L} and O_{1R} in the vertical direction when the binoculars 1 are in the vicinity of the infinity focused state shown in FIG. 3 and in the shortest distance focused state shown in FIG. 6 are compared with each other under assumption that the objective optical systems 21L and 21R are turned by the same angle, the displacement amount is less in a case where the object optical systems 21L and 21R are turned when the binoculars 1 are in the vicinity of the infinity focused state because of the relationship α<β described above. Therefore, even if an error or a difference occurs in manufacturing and/or assembling with respect to the positions of the guide rails 31L and 31R, it is possible to suppress the difference of the optical axes O_{1L} and O_{1R} in the vertical direction when the binoculars 1 are in the vicinity of the infinity focused state, which is the state frequently set.

In contrast to the embodiment, if α is greater than β, when a difference occurs in the positions of the guide rails 31L and 31R in manufacturing and/or assembling process, the difference of the optical axes O_{1L} and O_{1R} in the vertical direction is large when the binoculars are in the vicinity of the infinity focused state. Therefore, in such a configuration, the optical accuracy is lowered when the binoculars are in the infinity focused state, which is the state frequently set.

As shown in FIG. 3, when viewed from the direction of the optical axis O_{1R} of the objective optical system 21R, the distance D₁ from the center (optical axis O_{1R}) of the objective optical system 21R to the center of the guide shaft 11R is longer than the distance D₂ from the center (optical axis O_{1R}) of the objective optical system 21R to the projection 62R. The objective optical system 21L has the similar configuration. With such a configuration, since the distance D₁ is made relatively longer, it is possible to suppress the displacement of the optical axes O_{1L} and O_{1R} in the vertical direction when the convergence value compensation is carried out. Accordingly, the convergence value compensation can be made at a higher accuracy.

As an alternative, in order to obtain longer distance D₁ from the centers of the objective optical systems 21L and 21R to the centers of the guide shafts 11L and 11R, a window portion may be formed on the upper surface of the main body 3 and the guide shafts 11L and 11R are arranged outside the main body 3.

The binoculars 1 described above is configured such that the guide rails 31L and 31R include grooves formed on the inner wall of the lower side of the main body 3 and are integrated with the main body 3. Therefore, the number of components can be reduced, and assembling thereof can be facilitated. Accordingly, it is possible to incorporate the convergence value compensation mechanism while preventing an increase in the production costs thereof. Further, since the structure is simplified and the guide rails 31L and 31R can easily be formed at a high dimensional accuracy, it is possible to carry out convergence value compensation at a higher accuracy.

Furthermore, according to the above-described configuration, the guide rails 31L and 31R can be formed by molding. Therefore, it is possible to freely design the inclination angles of the guide rails 31L and 31R with respect to the optical axes O_{1L} and O_{1R}, and it is possible to change the inclination angles easily on the way, for example, at the boundary point between the inclination portions 311L and 311R and the parallel portions 312L and 312R. Therefore, it is possible to carry out convergence value compensation at the optimal conditions.

Optionally, a pressing member such as a spring, which presses the projections 62L and 62R to the sides of the guide rails 31L and 31R, may be provided. In this case, the guide rails 31L and 31R may not include grooves, but may include stepped portions having surfaces to which the projections 62L and 62R are press-contacted.

In the first embodiment, the guide rails 31L and 31R include grooves. However, the invention need not be limited to this configuration and can be modified. That is, the guide rails 31L and 31R may include convex lines and the lens frames 6L and 6R may be provided with grooves, into which the convex lines are inserted.

Although it is most preferable that the guide rails 31L and 31R are integrally formed on the main body 3 as in the first embodiment, rails composed as separate components may be fixed and adhered to the main body 3 by an adhering method.

Furthermore, as shown in FIG. 1, the binoculars 1 according to the first embodiment are configured such that, in use, the distance between the optical axes O_{1L} and O_{1R} of the objective optical systems 21L and 21R is always shorter than the distance between the optical axes O_{2L} and O_{2R} of the eyepiece optical systems 23L and 23R (distance between the emission side optical axes O_{22L} and O_{22R}). In other words, the maximum value of the distance between the optical axes O_{1L} and O_{1R} of the objective optical systems 21L and 21R (the state shown in FIG. 1) is made smaller than the distance between the optical axes O_{2L} and O_{2R} of the eyepiece optical systems 23L and 23R (the distance between the emission side optical axes O_{22L} and O_{22R}) in a state where the eye-width distance is adjusted to the minimum value (however, this refers to a state usable as binoculars and does not include a unusable, fully retracted state)

With such a configuration, in comparison with a roof prism type binoculars in which the distance between optical axes of both objective optical systems is equal to the distance between the optical axes of both eyepiece optical systems, and binoculars (Zeiss type and Bausch & Lomb type binoculars) in which the distance between the optical axes of both objective optical systems is larger than the distance between the optical axes of both eyepiece optical systems, a displacement amount of the objective optical systems 21L and 21R necessary for compensating for the convergence value can be smaller. The reason will be described below with reference to FIG. 7.

In FIG. 7, only the right side optical system is illustrated. Although omitted, the left side optical system has the same configuration as the right side one. In FIG. 7, the position of the right side objective optical system 100R for observing an object at the infinity is shown by a solid line. The objective-optical system 100R is moved closer to the center line of the binoculars in order to observe an object 200 at a finite distance a (adjustment value: a<0) from the objective optical system 100R in a state where the convergence value is compensated, and it is necessary that the objective optical system 100R is to be moved to the position indicated by a broken line. In this case, the movement distance y of the objective optical system 100R, which is obtained from FIG. 7 and an image formation formula l/b=l/a+l/f, is represented by an expression below:

$$\begin{matrix}y = b \times tan θ \\ = \{ f \times a / ( a + f ) \} \times tan θ \\ = \{ f \times a / ( a + f ) \} \times D / ( - a + b ) \\ = D \times [ f \times a / ( a + f ) / \{ - a + f \times a / ( a + f ) \} ] ,\end{matrix}$$

where, f represents the focusing distance of the objective optical system 100R, 2D represents the distance between the optical axes of both objective optical systems, 2θ represents a convergence angle, b denotes the distance from the objective optical systems to the image forming position of an object 200 by the objective optical system 100R (b>0).

That is, the movement distance y of the objective optical system 100R necessary to compensate for the convergence value is increased in proportion to D. In other words, as the distance between the optical axes of both objective optical systems is shorter, the displacement value of the objective optical systems necessary to compensate for the convergence value can be decreased.

In the binoculars 1 according to the first embodiment, since the distance between the optical axes O_{1L} and O_{1R} of the objective optical systems 21L and 21R is small, as described above, it is sufficient to move the objective optical systems 21L and 21R only slightly in the direction perpendicular to the optical axes O_{1L} and O_{1R} to compensate for the convergence value. Therefore, it is possible to incorporate a convergence value compensating mechanism without increasing the scale of the main body 3, and the entire binoculars 1 can be made compact.

Further, only slight movement distance of the objective optical systems 21L and 21R is sufficient for the convergence value compensation. Therefore, with an objective optical system turning system in which the objective optical systems 21L and 21R are turned to change the distance between the optical axes O_{1L} and O_{1R}, the compensation for the convergence value can be realized at a high accuracy. The objective optical system turning system has a simple structure, which contributes to a decrease in manufacturing costs thereof.

### Second Embodiment

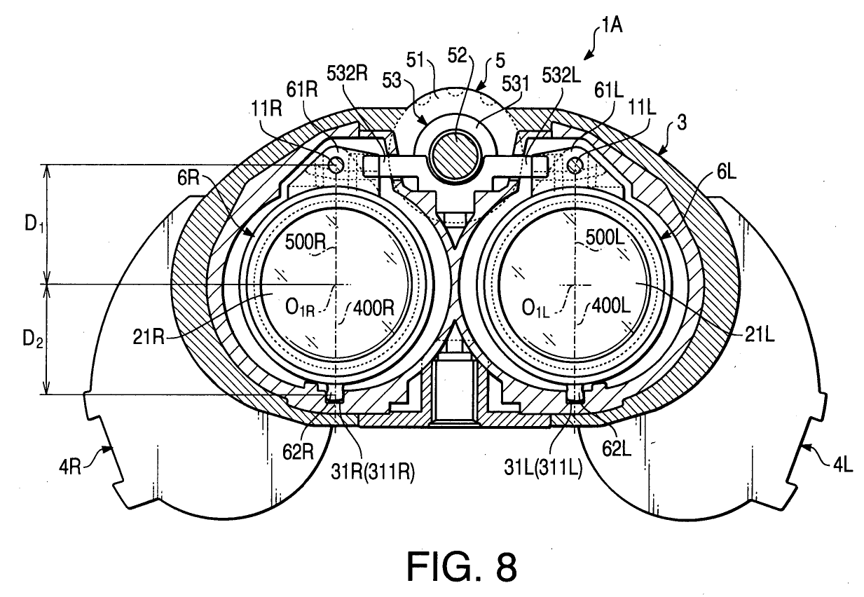

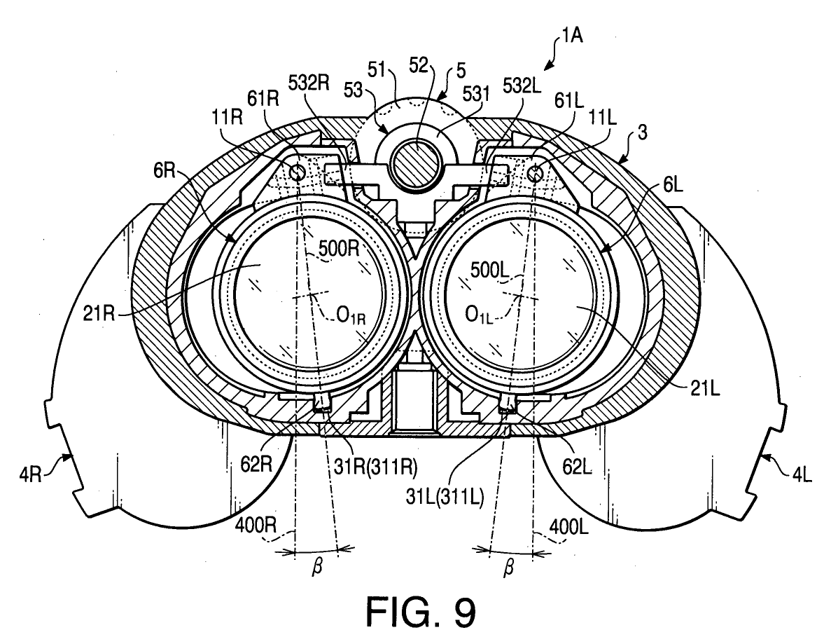

FIG. 8 is a sectional front view of the binoculars 1A according to a second embodiment of the invention in an infinity-focused state, and FIG. 9 is a sectional front view of the binoculars 1A according to the second embodiment of the invention in a shortest distance focused state. Hereinafter, a description is given of the binoculars 1A according to the second embodiment on the basis of these drawings. However, portions different from those of the first embodiment will be given, and a description of portions similar to those of the first embodiment will be omitted.

As shown in FIG. 8, in the binoculars 1A according to the second embodiment, when viewed along the directions of the optical axes O_{1L} and O_{1R}, in the infinity focused state, line segments 500L and 500R connecting the centers (optical axes O_{1L} and O_{1R}) of the objective optical systems 21L and 21R to the turning centers thereof (the centers of the guide shafts 11L and 11R) are substantially parallel to the vertical direction of the binoculars 1A. Further, as shown in FIG. 9, in the shortest distance focused state, the centers (optical axes O_{1L} and O_{1R}) of the objective optical systems 21L and 21R are located on inner sides of the straight lines 400L and 400R. That is, the binoculars 1A according to the second embodiment are regarded as equivalents to the binoculars 1 according to the first embodiment with the inclination angle a is substantially zero.

With such a construction, even if manufacturing and/or assembling errors are generated with respect to the positions of the guide rails 31L and 31R in the binoculars 1A, it is possible to minimize the difference of the optical axes O_{1L} and O_{1R} in the vertical direction when the binoculars 1A are in the vicinity of the infinity focused state, which is the frequently set state, and the optical accuracy can be further enhanced.

FIG. 8 is a sectional front view of the binoculars 1A according to a second embodiment of the invention in an infinity-focused state, and FIG. 9 is a sectional front view of the binoculars 1A in a shortest distance focused state. In the description regarding the second embodiment, only the differences with respect to the first embodiment will be described, and description regarding the parts which are similar to those of the first embodiment will be omitted.

As shown in FIG. 8, in the binoculars 1A according to the second embodiment, when viewed in the directions of the optical axes O_{1L} and O_{1R}, in the infinity focused state, line segments 500L and 500R connecting the centers (optical axes O_{1L} and O_{1R}) of the objective optical systems 21L and 21R to the turning centers thereof (the centers of the guide shafts 11L and 11R) extend in the vertical direction of the binoculars 1A and are substantially parallel to each other. Also, as shown in FIG. 9, in the shortest distance focused state, the centers (optical axes O_{1L} and O_{1R}) of the objective optical systems 21L and 21R are located on inner sides of the straight lines 400L and 400R. That is, the binoculars 1A are equivalent to such a type that the inclination angle α in the binoculars 1 according to the first embodiment is set to almost zero.

With such a configuration, even if manufacturing and/or assembling error occurs with respect to the positions of the guide rails 31L and 31R in the binoculars 1A according to Embodiment 2, it is possible to minimize the difference of the optical axes O_{1L} and O_{1R} in the vertical direction when the binoculars 1A are in the vicinity of the infinity focused state, which is frequently used, and the optical accuracy can be further enhanced.

As described above, a description was given of the illustrated embodiment of binoculars according to the invention. However, the invention is not limited thereto. Respective components that compose the binoculars may be substituted by any optional components which are capable of displaying performance similar thereto.

In the embodiments described above, each of the objective optical systems includes one lens group including two lenses, and focusing and convergence value compensation are carried out by moving the entirety of each objective optical system. However, the invention need not be limited to such an objective optical system and can be modified. For example, if each of the objective optical systems includes more than one lens groups, focusing and convergence value compensation may be carried out by moving a part of the lens groups constituting each objective optical system.

The present disclosure relates to the subject matters contained in Japanese Patent Application No. 2004-032561, filed on Feb. 9, 2004, which is expressly incorporated herein by reference in its entirety.

1. Binoculars which include a pair of observation optical systems each having an objective optical system, an erecting optical system and an eyepiece optical system, the binoculars comprising:
a focusing mechanism that is used to move a part of the observation optical system for focusing;
a convergence value compensating mechanism that compensates for a convergence value by turning displaceable elements which are at least parts of the objective optical systems, respectively, centering around straight lines parallel to optical axes of the displaceable elements in association with actuation of the focusing mechanism to vary a distance between the optical axes of the displaceable elements,
wherein, when viewed along the optical axis direction of the objective optical systems, centers of the displaceable elements are located on outer sides of lines respectively passing the turning centers of the displaceable elements and parallel to a vertical direction of the binoculars in a state where an observation object at infinity is focused,
wherein, when viewed along the optical axis direction of the objective optical systems, the centers of the displaceable elements are located on inner sides of lines respectively passing the turning centers of the displaceable elements and parallel to the vertical direction of the binoculars in a state where an observation object at a closest focusable distance is focused, and
wherein a condition:
α<β
is satisfied,
where, α represents an inclination angle of a line segment connecting the centers of the displaceable elements with the turning centers thereof, respectively, with respect to the vertical direction of the binoculars in a state where an object at infinity is focused, and β represents the inclination angle of a line segment connecting the centers of the respective object displacement elements to the turning centers thereof, respectively, with respect to the vertical direction in a state where an observation object at the closest focusable distance is focused.

2. The binoculars according to claim 1,
wherein each of the pair of observation optical systems is configured such that an incidence side optical axis and an emission side optical axis with respect to the erecting optical system are shifted from each other by a predetermined distance,
wherein the binoculars further include:
a main body that accommodates the pair of displaceable elements;
a left barrel containing the left eyepiece optical system and the left erecting optical system, the left barrel being turnable, with respect to the main body, about the left incidence side optical axis of the eyepiece optical system; and
a right barrel containing the right eyepiece optical system and the right erecting optical system, the right barrel being turnable, with respect to the main body, about the right incidence side optical axis of the eyepiece optical system, and
wherein a distance between the emission side optical axes of the pair of eyepiece optical systems is made adjustable by turning the left barrel and right barrel with respect to the main body.

3. The binoculars according to claim 1,
wherein the a focusing mechanism is configured to carry out focusing by moving the pair of displaceable optical elements,
wherein the binoculars further includes:
a pair of guide shafts corresponding to the pair of displaceable optical elements, the pair of guide shafts being arranged in parallel with the optical axes of the corresponding displaceable optical elements, the pair of guide shafts guiding the corresponding object displacement elements when moved by actuation of the focusing mechanism, the pair of guide shafts serving as turning centers of the corresponding object displacement elements, respectively;
a pair of engaging portions formed on a pair of frames that hold the pair of displaceable optical elements, respectively; and
a pair of guide rails provided with respect to the pair of displaceable optical elements, respectively, the pair of engaging portions being slidably engaged with the pair of guide rails, respectively, the pair of guide rails having inclined portions that incline with respect to the optical axes of the pair of displaceable optical elements at at least parts thereof, respectively,
wherein, when the pair of displaceable optical elements are moved for focusing with the pair of engaging portions being engaged with the inclined portions of the pair of guide rails, respectively, the pair of displaceable optical elements turn about the pair of guide shafts, respectively, a distance between the optical axes of the pair of displaceable optical elements changing as the pair of displaceable optical elements turn, whereby a convergence value is compensated.

4. The binoculars according to claim 3,
wherein, when viewed in the optical axes direction of the objective optical systems, a distance from the center of each of the pair of displaceable optical elements to the center of the corresponding one of the pair of guide shafts is longer than a distance from the center of the displaceable optical element to the engagement portion.

5. The binoculars according to claim 3,
wherein the focusing mechanism includes a focusing ring which is manually operable; and
wherein, when viewed in the optical axis direction of each of the objective optical systems, a distance from the center of the focusing ring to the center of corresponding one of the pair of guide shafts is shorter than a distance from the center of the focusing ring to the engagement portion.

6. The binoculars according to claim 3,
wherein the focusing mechanism includes a focusing ring which is manually operable; and
wherein, when viewed in the optical axis direction of the pair of objective optical systems, the pair guide shafts are arranged at substantially the same height as that of the focusing ring with respect to the vertical direction of the binoculars.

7. Binoculars which include a pair of observation optical systems each having an objective optical system, an erecting optical system and an eyepiece optical system, the binoculars comprising:
a focusing mechanism that is used to move a part of the observation optical system for focusing;
a convergence value compensating mechanism that compensates for a convergence value by turning displaceable elements which are at least parts of the objective optical systems, respectively, centering around straight lines parallel to the optical axes of the displaceable elements in association with actuation of the focusing mechanism to vary a distance between the optical axes of the displaceable elements,
wherein, when viewed in the optical axis direction of the objective optical systems, a line segment connecting each of the centers of the displaceable elements with corresponding one of the turning centers of the displaceable elements is substantially parallel to the vertical direction of the binoculars in a state where an observation object at infinity is focused, and
wherein, when viewed in the optical axis direction of the objective optical systems, a line segment connecting each of the centers of the displaceable elements with corresponding one of the turning centers of the displaceable elements is on an inner side of a line passing the turning center of the corresponding one of the displaceable elements and in parallel with the vertical direction of the binoculars in a state where an observation object at minimum focusable distance is focused.

8. The binoculars according to claim 7,
wherein each of the pair of observation optical systems is configured such that an incidence side optical axis of the eyepiece optical system, with respect to the erecting optical system, and an emission side optical axis of the eyepiece optical system are shifted from each other by a predetermined distance,
wherein the binoculars further include:
a main body that accommodates the pair of displaceable elements;
a left barrel containing the left eyepiece optical system and the left erecting optical system, the left barrel being turnable, with respect to the main body, about the left incidence side optical axis of the eyepiece optical system; and
a right barrel containing the right eyepiece optical system and the right erecting optical system, the right barrel being turnable, with respect to the main body, about the right incidence side optical axis of the eyepiece optical system, and
wherein a distance between the emission side optical axes of the pair of eyepiece optical systems is made adjustable by turning the left barrel and right barrel with respect to the main body.

9. The binoculars according to claim 7,
wherein the a focusing mechanism is configured to carry out focusing by moving the pair of displaceable optical elements,
wherein the binoculars further includes:
a pair of guide shafts corresponding to the pair of displaceable optical elements, the pair of guide shafts being arranged in parallel with the corresponding displaceable optical elements, the pair of guide shafts guiding the corresponding-object displacement elements when moved by actuation of the focusing mechanism, the pair of guide shafts serving as turning centers of the corresponding object displacement elements, respectively;
a pair of engaging portions formed on a pair of frames that hold the pair of displaceable optical elements, respectively; and
a pair of guide rails provided with respect to the pair of displaceable optical elements, respectively, the pair of engaging portions being slidably engaged with the pair of guide rails, respectively, the pair of guide rails having inclined portions that incline with respect to the optical axes of the pair of displaceable optical elements at at least parts thereof, respectively,
wherein, when the pair of displaceable optical elements are moved for focusing with the pair of engaging portions being engaged with the inclined portions of the pair of guide rails, respectively, the pair of displaceable optical elements turn about the pair of guide shafts, respectively, a distance between the optical axes of the pair of displaceable optical elements changing as the pair of displaceable optical elements turn, whereby a convergence value is compensated.

10. The binoculars according to claim 9,
wherein, when viewed in the optical axes direction of the objective optical systems, a distance from the center of each of the pair of displaceable optical elements to the center of the corresponding one of the pair of guide shafts is longer than a distance from the center of the displaceable optical element to the engagement portion.

11. The binoculars according to claim 9,
wherein the focusing mechanism includes a focusing ring which is manually operable; and
wherein, when viewed in the optical axis direction of each of the objective optical systems, a distance from the center of the focusing ring to the center of corresponding one of the pair of guide shafts is shorter than a distance from the center of the focusing ring to the engagement portion.

12. The binoculars according to claim 9,
wherein the focusing mechanism includes a focusing ring which is manually operable; and
wherein, when viewed in the optical axis direction of the pair of objective optical systems, the pair guide shafts are arranged at substantially the same height as that of the focusing ring with respect to the vertical direction of the binoculars.
